(19) United States
(12) Patent Application Publication
(10) Pub. No.: US 2026/0331969 A1
(43) Pub. Date: Oct. 22, 2026

(54) MOTOR FOR A TURNTABLE AND ASSOCIATED METHODS

(71) Applicant: WILSON BENESCH LIMITED, Sheffield (GB)

(72) Inventors: Jonathan TRAVIS, Sheffield (GB); Carl David BROOMFIELD, Knaresborough (GB); Neil David BROOMFIELD, Knaresborough (GB); Faris AL-NAEMI, Sheffield (GB); Graham COCKERHAM, Sheffield (GB); Craig MILNES, Sheffield (GB)

(21) Appl. No.: 19/106,883

(22) PCT Filed: Sep. 21, 2023
(86) PCT No.: PCT/GB2023/052451

§ 371 Date: Feb. 26, 2025

(30) Foreign Application Priority Data
Sep. 22, 2022 (GB) 2213837.4

(51) Int. Cl. H02K 1/14; H02K 1/278

(52) U.S. Cl. CPC H02K 1/146; H02K 1/278; H02K 2201/03; H02K 2213/03

(57) ABSTRACT

A motor for a turntable, comprising: a stator comprising a plurality of conductive coils, the conductive coils comprising a plurality of coil windings; and a rotor comprising a plurality of permanent magnets, wherein: the stator and the rotor are substantially concentrically arranged about a central axis of the motor, the plurality of coils are arranged with their central axes substantially radial with respect to the central axis of the motor, and there is a gap of at least 3 mm between the rotor and a face of each of the coil windings that is proximate the rotor.

### TECHNOLOGICAL FIELD

Examples of the disclosure relate to a motor for a turntable. Some relate to a motor for a turntable for transcribing vinyl.

### BACKGROUND

Electrical motors are used in a wide variety of applications and there are a wide range of factors to consider when designing an electrical motor. However, in general, electrical motors are developed according to the overarching goal of efficiency.

It would be desirable to provide an electrical motor that is enhanced and/or improved with respect to prior designs.

### BRIEF SUMMARY

According to various, but not necessarily all, embodiments there is provided a motor for a turntable, comprising:
a stator comprising a plurality of conductive coils, the conductive coils comprising a plurality of coil windings; and
a rotor comprising a plurality of permanent magnets, wherein:
   the stator and the rotor are substantially concentrically arranged about a central axis of the motor,
   the plurality of coils are arranged with their central axes substantially radial with respect to the central axis of the motor, and
   there is a gap of at least 3 mm between the rotor and a face of each of the coil windings that is proximate the rotor.

In some examples, the stator is radially exterior to the rotor.

In some examples, the gap is between an upper surface of each of the permanent magnets and a face of each of the coil windings that is proximate the rotor.

In some examples, the gap is greater than or equal to 3 mm and less than or equal to 30 mm.

In some examples, the stator comprises a metal ring with a diameter of approximately 375 mm and wherein the plurality of coils are mounted on the metal ring.

In some examples, the rotor comprises a substantially circular support with a diameter of approximately 280 mm for the plurality of permanent magnets.

In some examples, the plurality of coils have a substantially rectangular profile.

In some examples, the motor comprises a conductive alloy ring disposed between the stator and the rotor.

In some examples, the rotor is configured to support the conductive alloy ring.

In some examples, the stator and the rotor are mounted on a chassis with a diameter of approximately 380 mm.

In some examples, the motor is a direct drive motor.

In some examples, the gap is an air gap.

According to various, but not necessarily all, embodiments there is provided a turntable comprising a motor as described herein.

According to various, but not necessarily all, embodiments there is provided a method comprising: manufacturing a motor as described herein.

According to various, but not necessarily all, embodiments there is provided a method comprising: using a motor as described herein.

According to various, but not necessarily all, embodiments there is provided a method comprising: manufacturing a turntable as described herein.

According to various, but not necessarily all, embodiments there is provided a method comprising: using a turntable as described herein.

According to various, but not necessarily all, examples there is provided

According to various, but not necessarily all, examples there is provided examples as claimed in the appended claims.

The description of a function should additionally be considered to also disclose any means suitable for performing that function.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

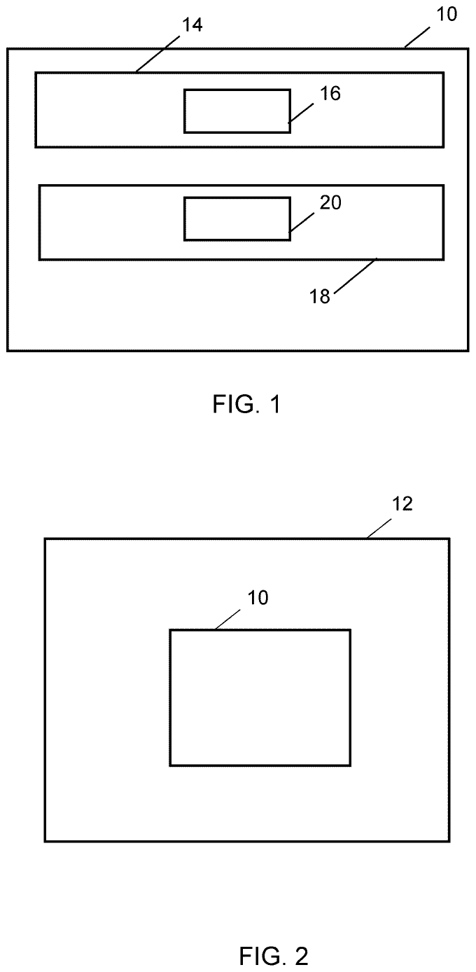

FIG. 1 shows an example of the subject-matter described herein;

FIG. 2 shows another example of the subject-matter described herein;

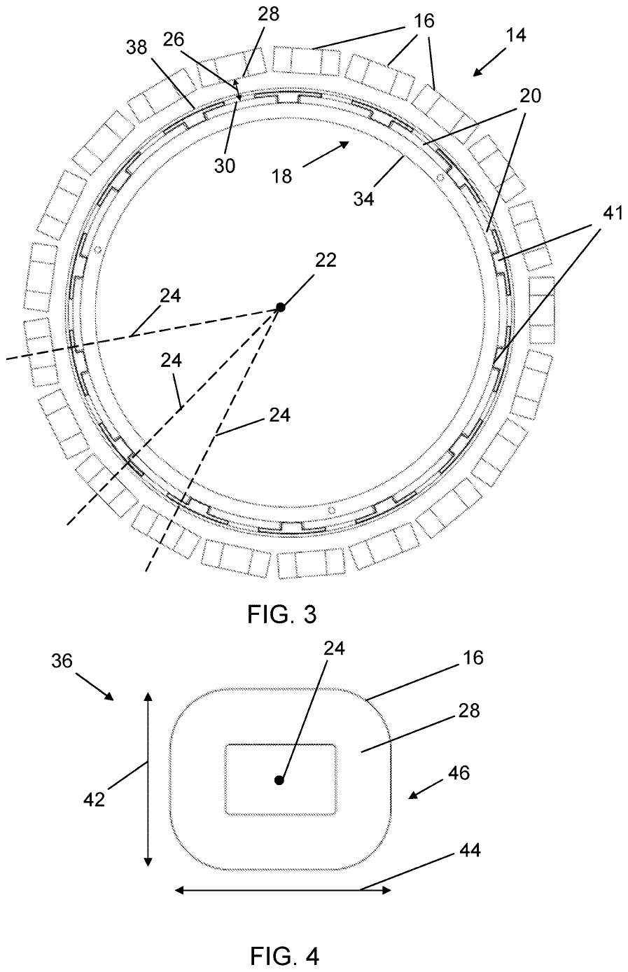

FIG. 3 shows another example of the subject-matter described herein;

FIG. 4 shows another example of the subject-matter described herein;

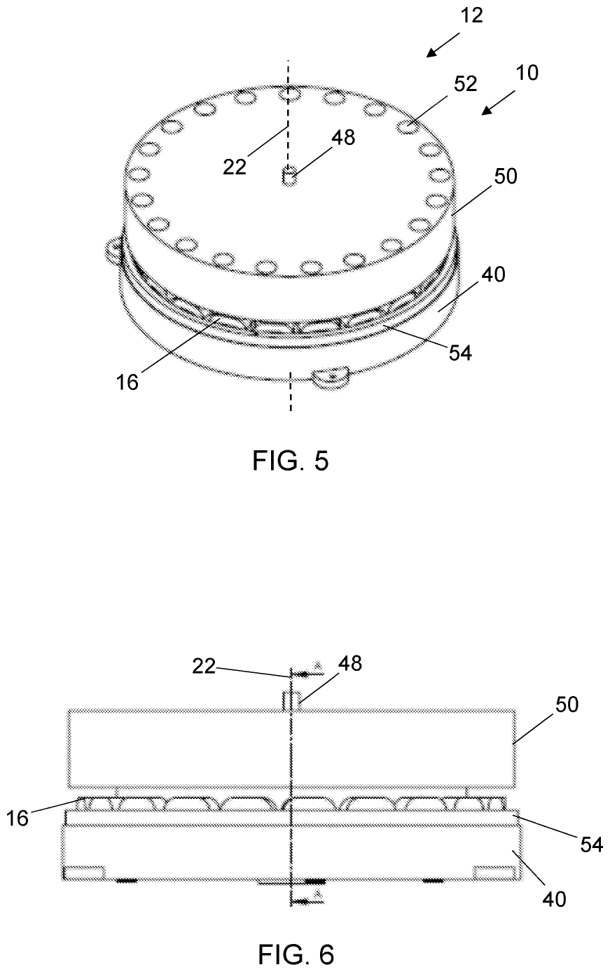

FIG. 5 shows another example of the subject-matter described herein;

FIG. 6 shows another example of the subject-matter described herein; and

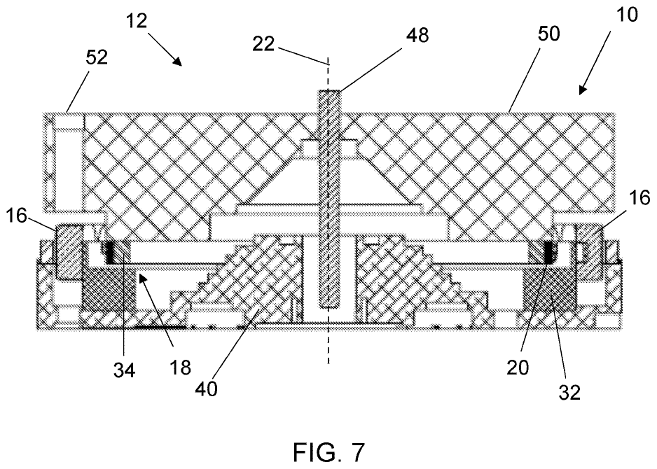

FIG. 7 shows another example of the subject-matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

Examples of the disclosure relate to a motor 10 for a turntable 12 and associated methods.

In examples, the motor 10 is configured to be used in a turntable 12 that is, for example, configured to be used in transcribing vinyl.

In examples, the motor comprises a stator 14 comprising a plurality of conductive coils 16, the conductive coils 16 comprising a plurality of coil windings, and a rotor 18 comprising a plurality of permanent magnets 20.

In examples, there is a gap 26, which can, in examples, be considered an air gap, of at least 3 mm between the rotor 18 and the closest part or parts of the stator 14 to the rotor 18.

In examples, the motor 10 is configured to provide high levels of precision, with vanishingly small levels of distortion, noise/vibration and outstanding reliability.

FIG. 1 schematically illustrates an example of a motor 10 for a turntable 12.

Various features referred to in relation to FIG. 1 can be found in the other FIGS. Furthermore, reference will be made to other FIGS. by way of example during the discussion of FIG. 1.

The motor 10 for a turntable 12 of FIG. 1 comprises:
a stator 14 comprising a plurality of conductive coils 16, the conductive coils 16 comprising a plurality of coil windings; and
a rotor 18 comprising a plurality of permanent magnets 20, wherein:
the stator 14 and the rotor 18 are substantially concentrically arranged about a central axis 22 of the motor 10,
the plurality of coils 16 are arranged with their central axes 24 substantially radial with respect to the central axis 22 of the motor 10, and
there is a gap 26 of at least 3 mm between the rotor 18 and a face 28 of each of the coil windings that is proximate the rotor 18.

In examples, the stator 14 can comprise any suitable stator 14. For example, the stator 14 can have any suitable size, shape and/or form.

For example, any suitable stator 14 that is configured to allow a gap 26 of at least 3 mm between a rotor 18 and a face 28 of each of the coil windings of conductive coils 16 of the stator 14 can be used.

In examples, the stator 14 is substantially circular and centered on/about a central axis 22 of the motor 10.

In some examples, the stator 14 comprises a metal ring 32 with a diameter of approximately 375 mm and wherein the plurality of coils 16 are mounted on the metal ring 32. See, for example, FIG. 7.

In such examples, the large diameter of the stator 14 provides high levels of accuracy in the rotational electromagnetic field.

The plurality of coils 16 can be mounted on the interior or exterior of the metal ring 32 with respect to the central axis 22 of the motor 10.

The metal ring 32 can comprise any suitable metal ring 32. For example, the metal ring 32 can have any suitable size, shape and/or form.

For example, any suitable metal ring 32 configured to allow the conductive coils 16 to be mounted such that the coils 16 are arranged with their central axes 24 substantially radial with respect to the central axis 22 of the motor 10 can be used.

The metal ring can comprise any suitable metal or metals. For example, the metal ring can comprise steel and/or any material having a similar iron content as steel and so on.

In examples, the metal ring 32 is formed from a single piece and is therefore not laminated.

The plurality of conductive coils 16 can comprise any suitable conductive coils 16. For example, the plurality of conductive coils 16 can have any suitable size, shape and/or form.

In examples, each of the plurality of conductive coils 16 is substantially similar and/or the same. For example, each of the conductive coils 16 can be the same within manufacturing tolerances.

The coils 16 can comprise any suitable conductive material formed and/or wound and/or made into any suitable coil configuration.

For example, each of the plurality of conductive coils 16 can have any suitable profile. In some examples, the plurality of coils 16 have a substantially rectangular profile.

By way of example, reference is made to the example of FIG. 4.

FIG. 4 schematically illustrates a side view of a conductive coil 16.

In the example of FIG. 4, the coil 16 has a substantially rectangular profile and a face 28 of the conductive coil 16 can be seen. A face 28 of the conductive coil 28 and/or coil winding can be considered an end and/or open end of the conductive coil 16.

In examples, each of the plurality of conductive coils 16 can have any suitable size. For example, a conductive coil 16 can have a width 44 in the range 19 mm to 25 mm, and/or a height 42 in the range 13 mm to 16 mm, and/or a depth 46 in the range 17 mm to 18 mm.

In the example of FIG. 4, the coil 16 has a width 44 of approximately 22 mm, a height 42 of approximately 14.5 mm and a depth 46 of approximately 16.5 mm. In the example of FIG. 4, the coil 16 has chamfers at the edges.

Returning to the discussion of FIG. 1, in examples, each of the plurality of conductive coils 16 can comprise any suitable number of turns. In some examples, each of the plurality of conductive coils 16 can comprise a number of turns in the range 127 to 147 turns. In some examples, at least one of the plurality of conductive coils comprises 137 turns.

In examples, the magnetic field transfer function of this approach provides for a diameter of over 350 mm low torque ripple design.

Each of the plurality of conductive coils 16 can have any suitable packing factor. In examples, each of the plurality of conductive coils 16 can have a packing factor in the range 88% to 92%. In some examples, at least one of the plurality of conductive coils 16 can have a packing factor of 90%.

Packing factor can be considered a measure of how well the material of the conductive coil 16 fills the space.

In examples, the coil 16 can comprise 12 windings per layer.

The plurality of conductive coils 16 can comprise and/or can be formed from any suitable conductive material. For example, the plurality of conductive coils 16 can comprise and/or be formed from any suitable conductive wire.

In examples, the plurality of conductive coils 16 comprise and/or are formed from copper wire with a diameter in the range 0.95 mm to 1.4 mm. In some examples, the plurality of conductive coils 16 comprise and/or are formed from copper wire with a diameter of 1.28 mm.

Any suitable number of coils 16 can be used. For example, 21 conductive coils 16 can be used.

In examples, the central axis 24 of a conductive coil 16 can be considered an axis passing through a central portion of the coil and about which the turns of the coil run.

In examples, a central axis 24 of a coil 16 can be considered an axis that passes through a central portion of the coil 16 and the centre of the open faces of the coil 16.

By way of example, reference is made to the example of FIG. 4.

In the example of FIG. 4, the central axis 24 of the coil 16 is located at the centre of the coil 16 and extends into/out of the page through the open face 28 of the coil 16.

Returning to the discussion of FIG. 1, in examples, the plurality of coils 16 are arranged with their central axes 24 substantially radial with respect to the central axis 22 of the motor 10.

In examples, the central axis 22 of the motor 10 can be considered the axis around which the rotor 18 and stator 14 are configured.

In examples, the central axis 22 of the motor 10 can be considered the axis around which the rotor 18 is configured to rotate.

Accordingly, in examples, the plurality of coils 16 are arranged with their central axes 24 at substantially radial directions with respect to the central axis 22 of the motor 10.

By way of example, reference is made to the example of FIG. 3.

FIG. 3 illustrates an example of a stator 14 and a rotor 18 concentrically arranged about a central axis 22 of the motor 10.

In the example of FIG. 3, the stator 14 comprises a plurality of conductive coils 16 which are, for example, as described/shown in the example of FIG. 4.

As can be seen in the example of FIG. 3, the plurality of conductive coils 16 are arranged around the central axis 22 of the motor 10 such that the central axes 24 of the plurality of coils 16 are substantially radial with respect to the central axis 22 of the motor 10.

That is, in examples, the plurality of conductive coils 16 are arranged such that the central axes 24 of the conductive coils 16 pass through the central axis 22 of the motor 10 and/or an area proximate the central axis 22 of the motor 10.

Returning to the discussion of FIG. 1, in examples, the rotor 18 can comprise any suitable rotor 18. For example, the rotor 18 can have any suitable size, shape and/or form.

For example, any suitable rotor 18 comprising a plurality of permanent magnets 20 and configured to allow a gap 26 of at least 3 mm between the rotor 18 and a face 28 of each of the coil windings of the stator 14 that is proximate the rotor 18 can be used.

For example, any suitable rotor 18 configured to support the plurality of permanent magnets 20 with a gap 26 of at least 3 mm to the face 28 of each of the coil windings that is proximate to the rotor 18 can be used.

In examples, the rotor 18 comprises a substantially circular support 34 for the plurality of permanent magnets 20.

In examples, the substantially circular support 34 can have any suitable size and/or form. For example, the substantially circular support 34 can have any suitable form to support the plurality of permanent magnets 20 at an inner and/or outer surface of the substantially circular support 34.

In some examples, the substantially circular support 34 has a diameter in the range 275 mm to 285 mm.

In some examples, the substantially circular support 34 has a diameter of approximately 280 mm.

Accordingly, in examples, the rotor 18 comprises a substantially circular support 34 with a diameter of approximately 280 mm for the plurality of permanent magnets 20.

The substantially circular support 34 can comprise any suitable material or materials. For example, the substantially circular support 34 can be formed from mild steel.

The plurality of permanent magnets 20 can comprise any suitable permanent magnets 20. For example, at least one of the plurality of permanent magnets 20 can comprise neodymium grade 45H with nickel plating.

In examples, at least one of the plurality of permanent magnets 20 can comprise a magnetic material other than neodymium.

In examples, at least one of the plurality of permanent magnets 20 can comprise a different specification of neodymium.

Each of the permanent magnets 20 can have any suitable size, shape and/or form. For example, each of the permanent magnets 20 can have any suitable size, shape and/or form to be supported on and/or by a substantially circular support 34.

In some examples, the permanent magnets have an arc profile. For example, the permanent magnets 20 can have an arc profile with an outer dimension of 290 mm, and an inner dimension of 280 mm and a thickness of 15 mm.

Any suitable number of permanent magnets 20 can be used.

In examples, 14 permanent magnets having alternating poles can be used. In some examples, the number of permanent magnets 20 and conductive coils 16 can be coordinated.

In examples, the permanent magnets 20 are evenly spaced on the substantially circular support 34 and can have spacers 41 located between each pair of permanent magnets 20. See, for example, FIG. 3.

In examples, the permanent magnets 20 can be mounted on the substantially circular support 34 in any suitable way using any suitable method. For example, the permanent magnets 20 can be bonded to the substantially circular support 34.

By way of example, reference is made to the example of FIG. 3. In the example of FIG. 3, the rotor 18 comprises a substantially circular support 34, in the form of a metal ring, on which the plurality of permanent magnets 20 are located.

In the example of FIG. 3, fourteen permanent magnets 20 are mounted on an outer surface of the circular support 34 with respect to the central axis 22 of the motor 10.

That is, in the example of FIG. 3, the plurality of permanent magnets 20 are located on the surface of the circular support 34 that is furthest away from the central axis 22 of the motor 10.

Furthermore, in the example of FIG. 3, a plurality of spacers 41 are located between the permanent magnets 20 to evenly space the permanent magnets 20 around the outer surface of the circular support 34.

Returning to the discussion of FIG. 1, in examples, the stator 14 and rotor 18 are substantially concentrically arranged about the central axis 22 of the motor 10.

Accordingly, in examples, the centre of the stator 14 and the centre of the rotor 18 are substantially collocated with the central axis 22 of the motor 10.

Accordingly, in examples, the stator 14 and the rotor 18 are configured substantially as concentric circles about the central axis 22 of the motor 10.

In examples, the stator 14 and the rotor 18 can be concentrically arranged about the central axis 22 of the motor 10 in any suitable way. For example, in examples the rotor 18 can be arranged inside the stator 14, meaning that the rotor 18 is closer to the central axis 22 of the motor 10.

For example, the rotor 18 can be arranged outside of the stator 14 meaning that the rotor 18 is further away from the central axis 22 of the motor 10 than the stator 14.

By way of example, reference is made to the example of FIG. 3.

In the example of FIG. 3, the rotor 18 and the stator 14 are arranged substantially concentrically about the central axis 22 of the motor 10.

In the example of FIG. 3 the rotor 18 is arranged inside the coils 16 of the stator 14, with respect to the central axis 22 of the motor 10, and the stator 14 is therefore radially exterior to the rotor 18.

Accordingly, in examples, the stator 14 is radially exterior to the rotor 18.

However, in some examples, the rotor 18 can be located outside of the stator 14 and therefore the rotor 18 can be radially exterior to the stator 14.

With reference to the example of FIG. 3, the circular support 34 of the rotor 18 could have a sufficiently large diameter to locate the circular support 34 outside of the plurality of coils 16 and, in such examples, the plurality of permanent magnets 20 can be located on an interior surface of the circular support 34 such that the plurality of permanent magnets 20 remain adjacent to the plurality of conductive coils 16 of the stator 14.

Referring again to the example of FIG. 1, in some examples, there is a gap 26 of at least 3 mm between the rotor 18 and a face 28 of each of the coil windings that is proximate the rotor 18.

In examples, the gap 26 is an air gap.

In examples, one or more elements may be positioned between the rotor 18 and the stator 14, however, in such examples, it can still be considered that there is a gap 26 between the rotor 18 and stator 14 as described herein.

In some examples, it can be considered that there is a gap 26 of at least 3 mm between the rotor 18 and the stator 14.

In some examples, it can be considered that there is a gap of at least 3 mm between the rotor 18 and the conductive coils 16 of the stator 14.

In some examples, it can be considered that there is a gap 26 of at least 3 mm between the rotor 18 and the stator 14 such that, in use, no part of the rotor 18 comes within 3 mm of any part of the stator 14.

In some examples, it can be considered that the rotor 18 is spaced from the stator 14 by at least 3 mm.

In examples, it can be considered that there is a gap 26 of at least 3 mm between the rotor 18 and a face 28 of each of the conductive coils 16 that is proximate the rotor 18.

In some examples, the gap 26 is between an upper surface 30 of each of the permanent magnets 20 and a face 28 of each of the coil windings that is proximate the rotor 18.

By way of example, reference is made to the example of FIG. 3.

As previously discussed, in the example of FIG. 3, the stator 14 is radially exterior to the rotor 18.

Accordingly, in the example of FIG. 3, the face 28 of the coil windings of the conductive coil 16/of the conductive coil 16 proximate to the rotor 18 is the face 28 closest to and facing the central axis 22 of the motor 10.

In the example of FIG. 3, the gap 26 between a face 28 of a conductive coil 16 and an upper surface 30 of a permanent magnet 20 is indicated by the double headed arrow between these elements.

As can be seen in the example of FIG. 3, as the rotor 18 rotates the gap 26 between the upper surface 30 of any of the plurality of permanent magnets 20 and the proximate face 28 of the plurality of conductive coils 16 remains greater than a value, which, in examples, is at least 3 mm.

Returning to the discussion of the example of FIG. 1, in examples, the gap 26 can have any suitable size greater than 3 mm. In some examples, the gap 26 is greater than or equal to 3 mm and less than or equal to 30 mm.

In some, but not necessarily all, examples, a motor 10 comprises a conductive alloy ring 38 disposed between the stator 14 and the rotor 18.

Any suitable conductive alloy ring 38 having any suitable size and/or form can be used.

For example, any suitable conductive alloy ring 38 configured to act against any deviation in the rotation of the rotor by virtue of eddy currents induced within the conductive alloy ring when disposed between the rotor 18 and the stator 14 can be used.

The conductive alloy ring 38 can comprise any suitable materials. For example, the conductive alloy ring 38 can comprise any suitable copper alloy, and suitable silver allow, any suitable aluminium alloy and so on.

In examples, the conductive alloy ring 38 can be considered a shielding ring and/or shading ring. For example, the conductive alloy ring 38 can, in examples, be considered a copper shading ring and/or copper shielding ring.

In some examples, the rotor 18 is configured to support the conductive alloy ring 38.

The rotor 18 can be configured in any suitable way to support the conductive alloy ring 38.

For example, one or more components of the rotor 18 can comprise one or more features and/or be configured to support the conductive alloy ring 38. For example, the spacers 41 can comprise a lip to support and/or locate the conductive alloy ring 38.

By way of example, reference is made to the example of FIG. 3.

In the example of FIG. 3, the motor 10 comprises a conductive alloy ring 38 supported by the rotor 18.

In the illustrated example, the conductive alloy ring 38 is a copper alloy ring supported by the spacers 41 of the rotor 18 to locate the copper alloy ring 38 between the rotor 18 and the stator 14.

Returning to the discussion of the example of FIG. 1, in examples, the stator 14 and rotor 18 are mounted on a chassis 40.

The chassis 40 can comprise any suitable chassis 40. For example, the chassis 40 can have any suitable shape, size and/or form.

For example, any suitable chassis 40 configured to mount the rotor 18 and stator 14 such that there is a gap 26 of at least 3 mm between the rotor 18 and a face 28 of each of the coil windings that is proximate the rotor 18 can be used.

In some examples, the chassis 40 has a diameter of at least 380 mm.

In examples, the chassis 40 has a diameter of approximately 380 mm. Accordingly, in examples, the stator 14 and the rotor 18 are mounted on a chassis 40 with a diameter of approximately 380 mm.

The chassis 40 can comprise any suitable material or materials. For example, the chassis 40 can comprise any suitable material or materials to prevent and/or limit thermal expansion of the chassis 40/system during use of the motor 10, for example in a turntable 12.

In examples, the chassis 40 can comprise aluminium, for example, the chassis 40 can be machined from a solid billet of aliminium to a specified tolerance, such a 0.01 mm, to allow the positional accuracy of the components that are mounted to the chassis 40 to be high.

The motor 10 can be any suitable type of motor. In some examples, the motor 10 is a direct drive motor. See, for example, FIGS. 5-7.

In examples, the motor 10 of FIG. 1 can comprise any number of additional components. In some examples, one or more components of the motor 10 of the example of FIG. 1 can be omitted and/or combined.

FIG. 2 schematically illustrates an example of a turntable 12.

In the example of FIG. 2, the turntable 12 comprises a motor 10 as described in relation to the example of FIG. 1. Accordingly, FIG. 2 illustrates a turntable 12 comprising a motor 10 as described herein.

In examples, the turntable 12 of FIG. 2 can comprise any number of additional components.

FIG. 5 illustrates a perspective view of an example of a turntable 12.

In the example of FIG. 5, the turntable 12 comprises a motor 10 as described herein.

In the example of FIG. 5, the motor 10 is located within a substantially circular chassis 40 and some of the plurality of conductive coils 16 of the stator 14 can be seen.

The turntable 12 comprises a platter 50 configured to be driven by the motor 10 to turn the platter as part of the functioning of the turntable 12. In the example of FIG. 5, the platter 50 comprises a plurality of platter weights 52.

Also illustrated in the example of FIG. 5 is a spindle 48 which coincides with a central axis 22 of the motor 10 and the turntable 12.

The turntable 12, in the example of FIG. 5, also comprises an outer ring 54. The outer ring 54 can comprise any suitable material or materials. For example, the outer ring 54 can comprise steel.

In the example of FIG. 5, the outer ring 54 is configured/acts to focus the magnetic field generated by the stator coils 16.

FIG. 6 illustrates a side view of the turntable 12 illustrated in the example of FIG. 5.

In the example of FIG. 6, the central axis 22 of the motor 10/turntable 12 can be seen. The central axis 22 is indicated with arrows A-A and a cross-section taken through A-A is shown in the example of FIG. 7.

As can be seen in the example of FIG. 7, the rotor 18 comprises a circular support 34 upon which the plurality of permanent magnets 20 are mounted.

Furthermore, in the example of FIG. 7, the stator 14 comprises a plurality of conductive coils 16 mounted on a metal ring 32.

In the example of FIG. 7, the rotor 18 and stator 14 are mounted on the chassis 40 and the rotor 18 is configured to turn the platter 50.

Also indicated in the example of FIG. 7 is the central axis 22 of the motor 10/turntable 12.

Examples of the disclosure are advantageous and/or provide technical benefits.

For example, examples of the disclosure provide a motor for a turntable that can operate the turntable with low/minimum torque ripple and cogging torque.

For example, examples of the disclosure provide a motor configured to produce high precision in terms of rotation velocity.

For example, examples of the disclosure provide a low noise motor configured to operate at low speed.

For example, examples of the disclosure provide a turntable configured such that any drag caused by the stylus interaction will have no impact on the speed of the system.

In some examples, there is provided a method of manufacturing a motor as described herein.

In some examples, there is provided a method of using a motor 10 as described herein.

In some examples, there is provided a method of manufacturing a turntable 12 as described herein.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A motor for a turntable, comprising:
a stator comprising a plurality of conductive coils, the plurality of conductive coils comprising a plurality of coil windings; and
a rotor comprising a plurality of permanent magnets, wherein:
the stator and the rotor are substantially concentrically arranged about a central axis of the motor,
the plurality of conductive coils are arranged with their central axes substantially radial with respect to the central axis of the motor, and
there is a gap of at least 3 mm between the rotor and a face of each coil winding that is proximate the rotor.

2. A motor as claimed in claim 1, wherein the stator is radially exterior to the rotor.

3. A motor as claimed in claim 1, wherein the gap is between an upper surface of each permanent magnet and a face of each coil winding that is proximate the rotor.

4. A motor as claimed in claim 1, wherein the gap is greater than or equal to 3 mm and less than or equal to 30 mm.

5. A motor as claimed in claim 1, wherein the stator comprises a metal ring with a diameter of approximately 375 mm and wherein the plurality of conductive coils are mounted on the metal ring.

6. A motor as claimed in claim 1, wherein the rotor comprises a substantially circular support with a diameter of approximately 280 mm for the plurality of permanent magnets.

7. A motor as claimed in claim 1, wherein the plurality of conductive coils have a substantially rectangular profile.

8. A motor as claimed in claim 1, comprising a conductive alloy ring disposed between the stator and the rotor.

9. A motor as claimed in claim 8, wherein the rotor is configured to support the conductive alloy ring.

10. A motor as claimed in claim 1, wherein the stator and the rotor are mounted on a chassis with a diameter of approximately 380 mm.

11. A motor as claimed in claim 1, wherein the motor is a direct drive motor.

12. A motor as claimed in claim 1, wherein the gap is an air gap.

13. A turntable comprising a motor as claimed in claim 1.

14. A method comprising:
manufacturing a motor as claimed in claim 1.

15. A method comprising:
using a motor as claimed in claim 1.

16. A method comprising:
manufacturing a turntable as claimed in claim 13.

17. A method comprising:
using a turntable as claimed in claim 13.
